(19) United States
(12) Patent Application Publication
(10) Pub. No.: US 2026/0322658 A1
(43) Pub. Date: Oct. 15, 2026

(54) METHOD AND APPARATUS FOR HANDLING CHANNEL VARIATION FEEDBACK REPORT BASED ON TRACKING REFERENCE SIGNALS (TRS)

(71) Applicant: Samsung Electronics Co., Ltd., Gyeonggi-do (KR)

(72) Inventors: Karthik MURALIDHAR, Bangalore (IN); Dattaraj Dileep Raut MULGAONKAR, Bangalore (IN); Diwakar SHARMA, Bangalore (IN); Santanu MONDAL, Bangalore (IN)

(21) Appl. No.: 19/117,107

(22) PCT Filed: Sep. 22, 2023
(86) PCT No.: PCT/KR2023/014530

§ 371 Date: Mar. 31, 2025

(30) Foreign Application Priority Data
Sep. 30, 2022 (IN) 202241056399
Nov. 7, 2022 (IN) 202241063375
Mar. 23, 2023 (IN) 202341020592
Sep. 15, 2023 (IN) 202241056399

(51) Int. Cl. H04L 25/02; H04W 8/22; H04W 76/20

(52) U.S. Cl. CPC H04L 25/0222; H04L 25/0224; H04W 8/22; H04W 76/20

(57) ABSTRACT

The disclosure relates to a 5^{th} generation (5G) or 6^{th} generation (6G) communication system for supporting a higher data transmission rate. Embodiments herein provide a method for handling channel variation feedback report based on Tracking Reference Signals (TRS) in a wireless network. The method includes receiving the tracking reference signals (TRS) from a network apparatus (202) in the wireless network, generating a channel variation feedback report based on the TRS, and sending the channel variation feedback report to the network apparatus (202).

### TECHNICAL FIELD

The disclosure relates to the field of mobile communication technology. More particularly, the disclosure relates to method and apparatus for channel variation feedback report from UE based on TRS.

This application is based on and derives the benefit of Indian Provisional Application 20/224,1056399 earliest filed on 30 Sep. 2022 claiming benefits of the Provisional Application 202241063375 filed on 7 Nov. 2022 and the Provisional Application 20/234,1020592 filed on 23 Mar. 2023.

### BACKGROUND ART

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

TRS (Tracking Reference Signal) and CSI-RS (Channel State Information Reference Signal) are used to feedback Doppler related information by UE to network apparatus (BS). The TRS-based feedback includes revisiting sampling periodicity and considering the number of lags of correlation and the doppler information to be fedback. The CSI-RS-based feedback includes length of time domain and number of time domain basis determination. Due to oscillator perfections, TRS helps in tracking variation in time and frequency to successfully receive downlink transmission. TRS is resource set consisting of multiple periodic Non Zero Power-CSI-RS (NZP CSI-RS). More, TRS consist of four one port, density-3 CSI-RS located within two consecutive slots.

However, there are some issues being faced by 5G systems while choosing the type of precoder depending, the SRS periodicity based on UE mobility etc. Typically, the TRS feedback based relate as to how TRS can be used to support this type of issues, what aspects of Doppler information can be fed-back, how many correlation lags can be feedback and how does the UE determine this information. The CSI-RS based feedback issue relates to how the network apparatus knows the length of CSI-RS burst and length of prediction window for the UEs. Therefore, there is a need for an advanced communication system to overcome the aforementioned issues.

The information disclosed in this background of the disclosure section is only for enhancement of understanding of the general background of the invention and should not be taken as an acknowledgement or any form of suggestion that this information forms the prior art already known to a person skilled in the art.

### DISCLOSURE OF INVENTION

### Technical Problem

The present disclosure relates to wireless communication systems and, more specifically, the invention relates to method and apparatus for handling channel variation feedback report based on tracking reference signals.

### Solution to Problem

In one aspect, the objects are achieved by providing a method for handling channel variation feedback report based on Tracking Reference Signals (TRS) in a wireless network includes receiving the TRS from a network apparatus in the wireless network. The method includes generating a channel variation feedback report by a UE based on the TRS. The channel variation feedback report includes Time domain correlation property (TDCP). The TDCP includes feedback of the quantized autocorrelation for correlation lags. The method includes sending the channel variation feedback report to a network apparatus from the UE.

In one embodiment, a method of a user equipment (UE) (201) is provided. The method for handling channel variation feedback report based on tracking reference signals (TRS) in a wireless network, includes, receiving the TRS from a network apparatus (202) in the wireless network, generating a channel variation feedback report based on the TRS, and sending the channel variation feedback report to the network apparatus (202).

In another embodiment, a method of a network apparatus (202) is provided. The method for handling channel variation feedback report based on tracking reference signals (TRS) in a wireless network includes configuring value for number correlation lags through higher layer RRC signaling at a UE (201), sending the TRS to the UE (201) in the wireless network (206), and receiving a channel variation feedback report from the UE (201) based on the TRS.

In yet another embodiment, a user equipment (UE) (201) is provided. The UE for handling channel variation feedback report based on tracking reference signals (TRS) in a wireless network includes a transceiver and a processor. And the processer is configured to receive the TRS from a network apparatus (202) in the wireless network, generate a channel variation feedback report based on the TRS, and send the channel variation feedback report to the network apparatus (202).

In yet another embodiment, a network apparatus (202) is provided. The network apparatus for handling channel variation feedback report based on tracking reference signals (TRS) in a wireless network includes a transceiver and a processor. And the processer is configured to configure value for number correlation lags through higher layer RRC signaling at a UE (201), send the TRS to the UE (201) in the wireless network (206), and receive a channel variation feedback report from the UE (201) based on the TRS.

In an embodiment, the includes receiving the channel variation feedback report to the network apparatus for performing one of configuring the UE based on a higher-layer (RRC) signaling and determining UE capabilities and receiving the channel variation feedback report to obtain a Doppler value to derive at least one parameter length of Doppler basis (N4), and wherein the at least one parameter length of Doppler basis (N4) is configured to the UE using higher-layer (RRC) signaling.

In another aspect the objects are achieved by providing a method for generating the channel variation feedback report based on the TRS. The method includes determining frequency and time offsets in the between the network apparatus and the UE. The method includes determining a downlink channel by the UE and performing quantized autocorrelation from the downlink channel to obtain candidate values for correlation lags. The method includes generating the channel variation feedback report based on the candidate values for the correlation lags and candidate values for number of correlation lags. The candidate values for number of correlation lags are configured by the network apparatus through higher layer RRC signaling.

In yet another aspect the objects are achieved by providing a method for sending the channel variation feedback report to the network apparatus. The method includes varying the candidate values for number of correlation lags to be reported to the network apparatus based on a linear interpolation model and a quantization model. The method includes reporting candidate values for number of correlation lags depends on the UE capability to the network apparatus. The method includes determining a power spectral density (PSD) based on the various lags and the candidate values for correlation lags. The method includes obtaining normalized Doppler spread and identifying speed of the UE. The power spectral density (PSD), and Doppler spectrum is Fast Fourier Transform (FFT) of the candidate values for correlation lags are followed by an absolute and squared operation.

In yet another aspect the objects are achieved by providing a method for handling channel variation feedback report based on Tracking Reference Signals (TRS) in a wireless network. The method includes configuring value for number correlation lags by the network apparatus, through higher layer RRC signaling at the UE. The method includes sending the TRS to the UE in the wireless network. The method includes receiving the channel variation feedback report based on the TRS. The method includes adjusting a beam forming operation between the UE and the network apparatus based on the channel variation feedback report.

In yet another aspect the objects are achieved by providing a method for configuring values for correlation lags through higher layer RRC signaling at the UE. The system includes detecting capability information of the UE. The method includes configuring values for number correlation lags through the higher layer RRC signaling at the UE based on the capability information of the UE. The method includes receiving Doppler information by the network apparatus from a TRS-TDCP feedback and CSI-RS feedback from the UE. The capability information of the UE includes the candidate values number of lags supported by the UE.

In yet another aspect the objects are achieved by providing a UE for handling channel variation feedback report based on Tracking Reference Signals (TRS) in a wireless network. The UE includes a memory, a processor, and a Tracking Reference Signals (TRS) controller. The Tracking Reference Signals (TRS) controller communicatively coupled to the memory and the processor configured to receive the TRS from a network apparatus in the wireless network, generate a channel variation feedback report based on the TRS, and send the channel variation feedback report to the network apparatus.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### Advantageous Effects of Invention

Advantages, and salient features of the invention will become apparent to those skilled in the art from the following detailed description, which, taken in conjunction with the annexed drawings, discloses exemplary embodiments of the invention.

According to various embodiments of the present disclosure, method and apparatus for handling channel variation feedback report based on tracking reference signals.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1A is a schematic diagram illustrating a TRS structure consisting of four one-port, density-3 CSI-RS located within two consecutive slots, according to a prior art;

FIG. 1B is a schematic diagram illustrating the TRS structure, according to a prior art;

FIG. 2 is a block diagram illustrating a scenario of handling channel variation feedback report based on Tracking Reference Signals (TRS) in a wireless network, in accordance with some embodiments of the present disclosure;

FIG. 3 is a graph illustrating doppler spread proportional to speed, in accordance with some embodiments of the present disclosure;

FIG. 4 is a graph illustrating quantization levels and their bits representation, in accordance with some embodiments of the present disclosure;

FIG. 5 is a graph illustrating the power spectral density for various speeds wherein the normalized Doppler spread is proportional to speed, in accordance with some embodiments of the present disclosure;

FIG. 6 is a graph illustrating the Doppler spread with number of lags, in accordance with some embodiments of the present disclosure;

FIG. 7 is a graph illustrating the variation of doppler spread vs. number of correlation lags in PSD calculation, in accordance with some embodiments of the present disclosure;

FIG. 8 is a graph illustrating a delay-doppler, in accordance with some embodiments of the present disclosure;

FIG. 9A is a graph illustrating a real part of correlation lag, in accordance with some embodiments of the present disclosure;

FIG. 9B is a graph illustrating an imaginary part of correlation lag, in accordance with some embodiments of the present disclosure;

FIG. 10 is a graph illustrating the power spectral density for various lags computed from the feedback of unquantized correlation lags values, in accordance with some embodiments of the present disclosure;

FIG. 11 is a graph illustrating the power spectral density for various correlation lags and velocities computed from feedback of unquantized correlation value for lags, in accordance with some embodiments of the present disclosure;

FIG. 12 is a graph illustrating normalized unquantized autocorrelation vs quantized or/and linear interpolated for various correlation lags, in accordance with some embodiments of the present disclosure;

FIG. 13 is a graph illustrating the power spectral density for various correlation values at the network apparatus with linear interpolation and unquantized at the UE, in accordance with some embodiments of the present disclosure;

FIG. 14 is a graph illustrating an autocorrelation for 15 lags using 3-bit quantization with varying quantization level, in accordance with some embodiments of the present disclosure; and

FIG. 15 is a flow chart illustrating a method for handling channel variation feedback report based on Tracking Reference Signals (TRS) in a wireless network, according to the embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

In an embodiment, the maximum speed supported by TRS depends on periodicity of P slots. Further, fD in Hertz is considered as the Doppler frequency, sampling time is T in seconds and depends on periodicity of slots as well as the slot duration which is dependent on subcarrier spacing. Given that, fD=(v/c) fc where v is the speed of UE, c is speed of light and fc is carrier frequency. The power spectral density (PSD) of the signal typically lies between −fDT+foT and fDT+foT, where foT may be a normalized frequency offset or a Doppler shift, 2fDT is the normalized Doppler spread or frequency. Wherein, fDT to be between 0 and 0.5 to prevent aliasing or to satisfy Nyquist sampling theorem. Therefore, the maximum supported speed depends on periodicity of P slots.

In an embodiment, the normalized Doppler spread is proportional to speed. Therefore, when a UE feedback correlation values for lags, a network apparatus (gNB) may compute PSD, estimate normalized Doppler spread and identify speed of the UE. Further, the correlation values could be averaged across TRS subcarriers. For carrier frequency 3.5 GHz, subcarrier spacing 30 kHz periodicity of 4 slots, the maximum supported speed is 60 km/hr.

To support higher speeds, greater than 100 km/hr, in an embodiment, the present disclosure proposes to change the minimum value of P=2 slots, when the basic TRS lies over two consecutive slots (effectively having a TRS every slot) or P=1 slot for a basic TRS lying in one slot only (effectively having a TRS every slot). The minimum value can also have lesser than P=4 slots or a configurable any value of P. Furthermore, other variants could be to introduce offsets between the TRS pilots in different subcarriers, changing the frequency separation between TRS and the like. Accordingly, the embodiments disclose a method for handling channel variation feedback report based on Tracking Reference Signals (TRS) in a wireless network. The method includes receiving the TRS from a network apparatus in the wireless network. The method includes generating a channel variation feedback report by a UE based on the TRS. The channel variation feedback report includes Time domain correlation property (TDCP). The TDCP includes feedback of the quantized autocorrelation for correlation lags. The method includes sending the channel variation feedback report to a network apparatus from the UE. The method includes receiving the channel variation feedback report by the network apparatus to derive length of CSI-RS burst and parameter length of Doppler basis (N4). Further, the method includes deriving the parameter length of Doppler basis (N4) based on the UE capability and the channel variation feedback report to obtain a Doppler value. Also, in another embodiment, the method includes configuring the parameter length of Doppler basis (N4) to the UE using a higher-layer (RRC) signaling.

Accordingly, the embodiments disclose a UE for handling channel variation feedback report based on Tracking Reference Signals (TRS) in a wireless network. The UE includes a memory, a processor, and a Tracking Reference Signals (TRS) controller. The Tracking Reference Signals (TRS) controller communicatively coupled to the memory and the processor configured to receive the TRS from a network apparatus in the wireless network, generate a channel variation feedback report based on the TRS, and send the channel variation feedback report to the network apparatus.

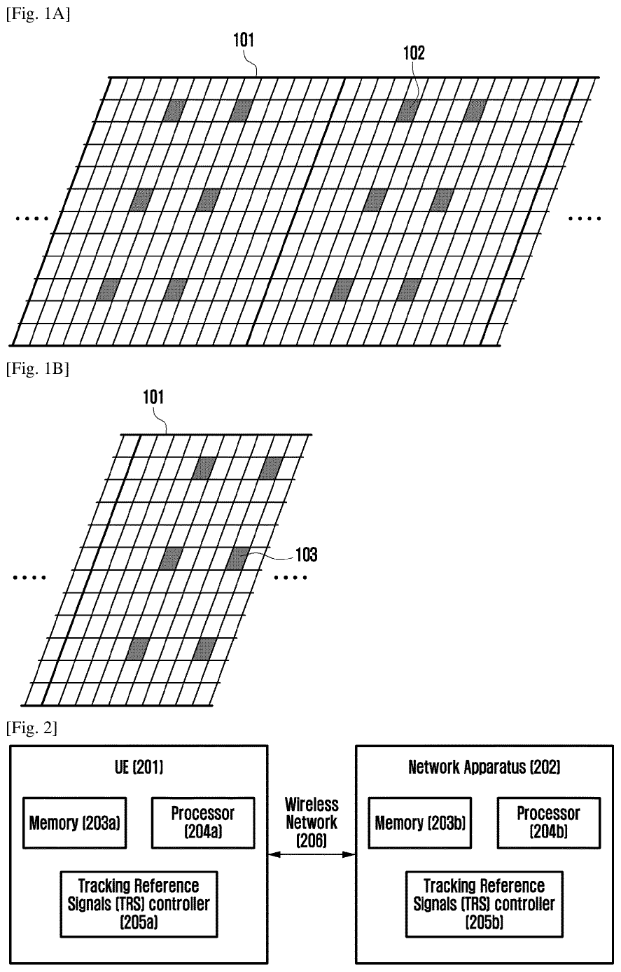

FIG. 1A is a schematic diagram illustrating a TRS structure consisting of four one-port, density-3 CSI-RS located within two consecutive slots, according to a prior art;

Referring to FIG. 1A includes a Tracking Reference Signals (TRS) structure (101). The TRS structure (101) includes four one-port density-3 CSI-RS (102). The TRS structure (101) implies that CSI-RS within the resource set and thus also the TRS structure (101) may be configured with a periodicity of P slots, while the exact set of resource elements such as subcarriers and orthogonal frequency-division multiplexing (OFDM) symbols used for TRS CSI-RS may vary. Although a four-symbol time-domain separation between the two CSI-RS is present within a slot, however, this time-domain separation sets the limit for the frequency error that may be tracked. Similarly, the frequency-domain separation (four subcarriers) sets the limit for the timing error that may be tracked.

Further, the TRS is used to feedback Doppler related information by the UE to the network apparatus. The UE may include, but not limited to, a mobile, an electronic device, a computing device, and the like. The network apparatus may include, but not limited to, a gNB, a base station, and the like. Particularly, the TRS feedback reports time domain correlation channel values which are autocorrelation calculated from the TRS signal. Generally, these values are quantized by the UE before being sent to the network apparatus.

FIG. 1B is a schematic diagram illustrating a TRS structure, according to a prior art. FIG. 1B is an alternative TRS structure with same per-slot structure as the TRS structure in FIG. 1A, but only consisting of two CSI-RS within a single slot instead of two consecutive slots, according to a prior art used in FR2 case.

Referring to FIG. 1B includes two one port density-2 CSI-RS (103). The two one port density-2 CSI-RS (103) are within a single slot instead of two consecutive slots, In an embodiment, a quantization is a process of mapping input values from a large set (often a continuous set) to output values in a (countable) smaller set, often with a finite number of elements. The difference between the input value and its quantized value (such as round-off error) may be referred to as quantization error. Each sample value is mapped to a discrete level (represented by a sequence of bits) in a process. In a B-bit quantizer, each quantization level is represented with B bits, so that the number of levels equals 2B.

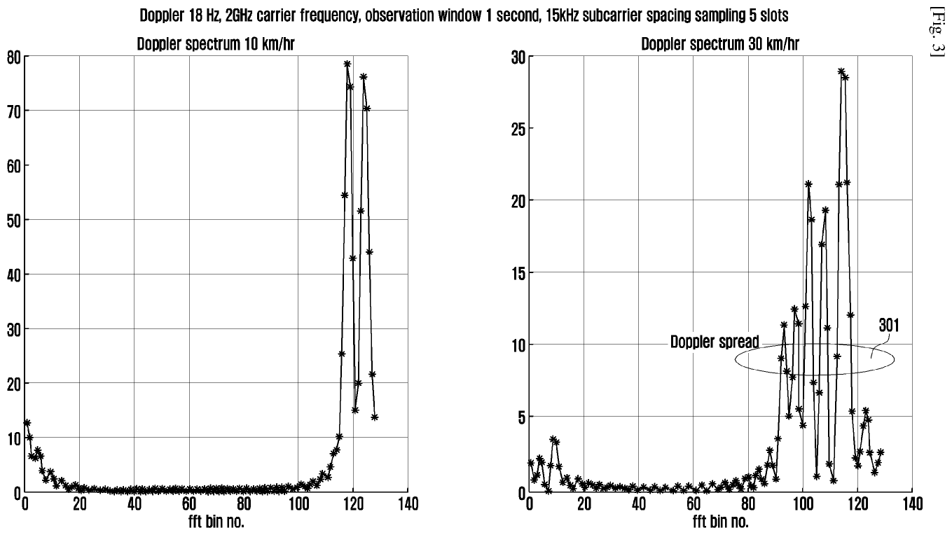

FIG. 2 is a block diagram illustrating a scenario of handling channel variation feedback report based on Tracking Reference Signals (TRS) in a wireless network, in accordance with some embodiments of the present disclosure;

Referring to FIG. 2 includes a UE (201), a network apparatus (202), and a wireless network (206). The UE (201) includes a memory (203a), a processor (204a), and a Tracking Reference Signals (TRS) controller (205a). The network apparatus (202) includes a memory (203b), a processor (204b), and a Tracking Reference Signals (TRS) controller (205b).

In an embodiment, the UE (201) for handling channel variation feedback report based on Tracking Reference Signals (TRS) in the wireless network (206) includes the Tracking Reference Signals (TRS) controller (205a) communicatively coupled to the memory (203a) and the processor (205a) configured to receive the TRS from the network apparatus (202) in the wireless network (206).

The memory (203a) is configured to store instructions to be executed by the processor (204a). The memory (203a) includes nonvolatile storage elements. Examples of such nonvolatile storage elements includes magnetic hard discs, optical discs, floppy discs, flash memories, or forms of Electrically Programmable Memories (EPROM) or Electrically Erasable and Programmable Memories (EEPROM). In addition, the memory (203a) in some examples, be considered a nontransitory storage medium. The term “non-transitory” indicates that the storage medium is not embodied in a carrier wave or a propagated signal. The term “nontransitory” is not be interpreted that the memory (203a) is non-movable. In some examples, the memory (203a) is configured to store larger amounts of information. In certain examples, a non-transitory storage medium stores data that can, over time, change (e.g., in Random Access Memory (RAM) or cache). The processor (204a) includes one or a plurality of processors.

The one or the plurality of processors is a general-purpose processor, such as a central processing unit (CPU), an application processor (AP), or the like, a graphics processing unit such as a graphics processing unit (GPU), a Visual Processing Unit (VPU), and/or an AI dedicated processor such as a neural processing unit (NPU). The processor (204a) includes multiple cores and is configured to execute the instructions stored in the memory (203a).

The UE (201) may be configured to generate a channel variation feedback report based on the TRS, and send the channel variation feedback report to the network apparatus (202). The channel variation feedback report includes Time domain correlation property (TDCP). The TDCP includes feedback of the quantized amplitude autocorrelation for correlation lags. The candidate values for number correlation lags may be configured by the network apparatus (202) through higher layer RRC signaling.

In an embodiment, the network apparatus (202) for handling channel variation feedback report based on Tracking Reference Signals (TRS) in the wireless network (206) includes the Tracking Reference Signals (TRS) controller (205b), communicatively coupled to the memory (203b) and the processor (204b).

The memory (203b) is configured to store instructions to be executed by the processor (204b). The memory (203b) includes nonvolatile storage elements. Examples of such nonvolatile storage elements includes magnetic hard discs, optical discs, floppy discs, flash memories, or forms of Electrically Programmable Memories (EPROM) or Electrically Erasable and Programmable Memories (EEPROM). In addition, the memory (203b) in some examples, be considered a nontransitory storage medium. The term “non-transitory” indicates that the storage medium is not embodied in a carrier wave or a propagated signal. The term “nontransitory” is not be interpreted that the memory (203b) is non-movable. In some examples, the memory (203a) is configured to store larger amounts of information. In certain examples, a non-transitory storage medium stores data that can, over time, change (e.g., in Random Access Memory (RAM) or cache). The processor (204b) includes one or a plurality of processors.

The one or the plurality of processors is a general-purpose processor, such as a central processing unit (CPU), an application processor (AP), or the like, a graphics processing unit such as a graphics processing unit (GPU), a Visual Processing Unit (VPU), and/or an AI dedicated processor such as a neural processing unit (NPU). The processor (204b) includes multiple cores and is configured to execute the instructions stored in the memory (203b).

The network apparatus (202) may be configured to receive the channel variation feedback report from the UE (201) to derive the parameter length of CSI-RS burst and Doppler basis (N4). The parameter length of Doppler basis (N4) may be derived based on the UE (201) capability and the channel variation feedback report to obtain a Doppler value. The network apparatus (202) may configure the parameter length of Doppler basis (N4) to the UE (201) using a higher-layer (RRC) signaling.

The network apparatus (202) may configure value for number correlation lags through higher layer RRC signaling at the UE (201). The network apparatus (202) may be configured to send the TRS to the UE (201) in the wireless network. The network apparatus (202) may be configured to receive a channel variation feedback report from the UE (201) based on the TRS. The network apparatus (202) may be configured to detect the capability information of the UE (202). The capability information of the UE (201) includes the candidate values number of lags supported by the UE (201). The network apparatus (202) may configure the values for number correlation lags through the higher layer RRC signaling at the UE (201) based the capability information of the UE (201).

Although not shown in the drawing, the UE (201) may be equipped with a transceiver, and the UE (201) may transmit and receive signals to and from the network apparatus (202) through the transceiver. And although not shown in the drawing, the network apparatus (202) may include a transceiver, and the network apparatus (202) may transmit and receive signals to and from the UE (201) through the transceiver.

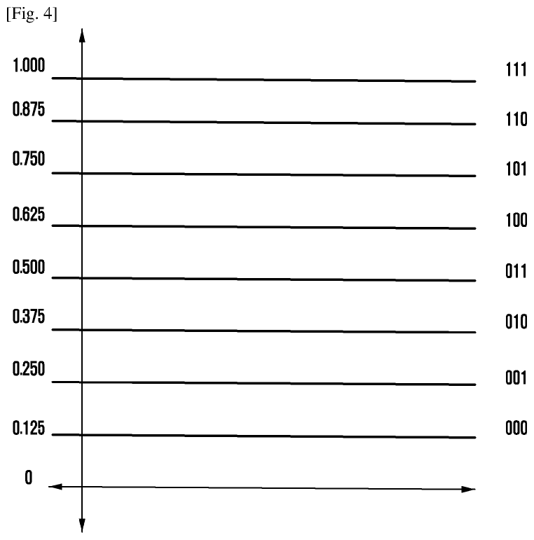

FIG. 3 is a graph illustrating doppler spread proportional to speed, in accordance with some embodiments of the present disclosure;

Referring to FIG. 3 depicts a Doppler spread (301).

Maximum speed supported: fD in Hertz is the Doppler frequency, sampling time T in seconds depends on periodicity of slots as well as the slot duration which is dependent on subcarrier spacing. fD=(v/c) fc where v is the speed of the UE (201), c is speed of light and fc is carrier frequency.

The power spectral density (PSD) of the signal typically lies between −fDT+foT and fDT+foT where foT may be a normalized frequency offset or a Doppler shift, 2fDT is the normalized Doppler spread or frequency. Note that fDT may be between 0 and 0.5 to prevent aliasing or to satisfy the Nyquist sampling theorem. Hence, the maximum supported speed depends on periodicity of P slots.

The normalized Doppler spread (301) is proportional to speed. So, when the UE (101) feedback correlation value for lags, the network apparatus (102) may compute PSD, estimate normalized Doppler spread and identifies the speed of the UE (101). The correlation values for lags could be averaged across TRS subcarriers.

For carrier frequency 3.5 GHz, subcarrier spacing 30 kHz periodicity of 4 slots, the maximum supported speed is 60 km/hr. However, there is a need to support higher speeds, possibly greater than 100 km/hr. Therefore, it is proposed to change the minimum value of P=2 slots, when the basic TRS lies over two consecutive slots (effectively having a TRS every slot) or P=1 slot for a basic TRS lying in one slot only (effectively having a TRS every slot). Or we can have lesser than P=4 slots or a configurable any value of P. Other variants may introduce offsets between the TRS pilots in different subcarriers, changing the frequency separation between TRS and the like.

In the present disclosure, PSD (power spectral density) or Doppler spectrum is FFT of correlation values, followed by an absolute and squared operation. So it's just a choice of reporting: correlation values or speed from Doppler spectrum. PSD and correlation are equivalent and may move from one domain to another via FFT/IFFT. For K correlation values, via FFT, and report more than K PSD values. Bandwidth of Doppler spectrum may be proportional to speed such that the network apparatus (202) may also request specific correlation lags to be feedback.

For example, as illustrated in the FIG. 2A, as speed increases, Doppler spread increases. So, the UE (201) may just inform the Doppler spread (301), or selected values of PSD. In an embodiment, precise information of the speed may not be required. Instead, it may be sufficient if low speed corresponds to be 0-30 km/hr, mid speed to be 30-90 km/hr, and high speed to be greater 90 km/hr.

The network apparatus (202) may interpolate correlation values. If PSD values are reported (denoted by s(f)), and an up sampling of two in correlation values is required (interpolate one correlation value between two reported correlation values), the network apparatus (202) may compress the PSD (determine s′(f)=s(2f)) do IFFT on s′(f) to determine the intermediate correlation values.

Further, in order to identify how many correlation lags are reported by the UE (201), the number of correlation lags to be reported by the UE (201) may be decided by the UE (201) and be part of a time-domain channel properties (TDCP) report. The TDCP report may be in PUSCH/PUCCH. Further, it may be configured by the network apparatus (202) as well through RRC or MAC-CE. For a given subcarrier spacing, periodicity P, carrier frequency, the maximum speed supported are all related. In an embodiment, the PSD may be calculated by doing FFT of the correlation lags and taking square of the absolute of each term. The perceived Doppler spread (301) at the network apparatus (202) depends on number of correlation lags reported, called as windowing effect.

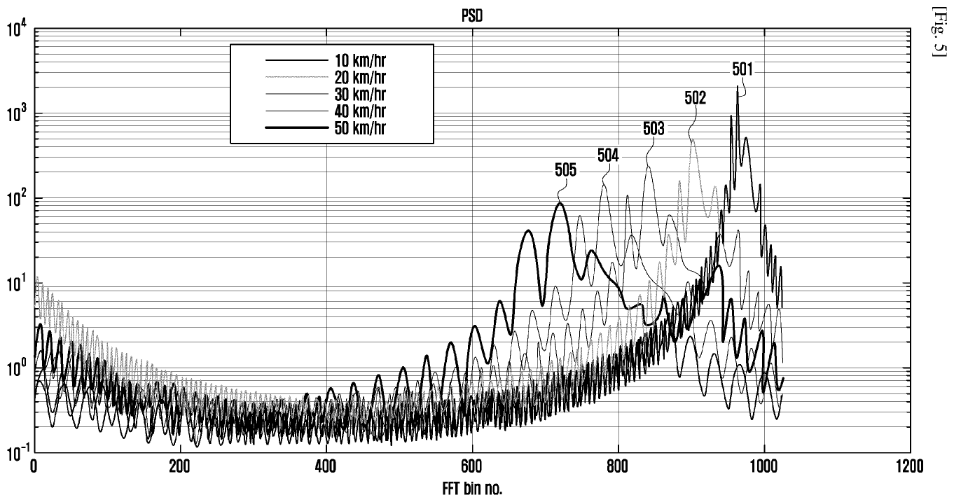

FIG. 4 is a graph illustrating quantization levels and their bits representation, in accordance with some embodiments of the present disclosure;

In an embodiment, an interval between the levels may be set depending on the range of the values according to the state of the art. For instance, for B bits quantization, the whole range may be divided by 2B. Any value within the interval may be set to the nearest level. FIG. 4 depicts an exemplary embodiment with the quantization step size of 0.125 and range 1. For example, for value 0.135, it may be set as 0.125 being closest in the interval and its representation is 000 bits.

The mean quantization error may be calculated using the relation

$$\frac{{( stepsize )}^{2}}{12} .$$

This relation implies that the error also reduces as the step size decreases. Linear interpolation is method where, value is estimated based on adjacent values

$$y = {y}_{1} + ( x - {x}_{1} ) * \frac{y 2 - y 1}{x 2 - x 1} \qquad ( i )$$

Where (x₁, y₁), (x₂, y₂) are known points and (x, y) are points where for given, y value is estimated based on slope of known points. It is one of the simplest methods for interpolation. Slope of new value remains same. Error is high in linear interpolation to compare to polynomial based interpolation.

Additionally, the number of correlation values for lags to be reported by the UE (201) may be decided by the UE (202) and be part of the TDCP report, while the UE (202) may be configured by the network apparatus (202) as well. For a given subcarrier spacing, periodicity P, carrier frequency a maximum speed supported are all related. The PSD may be calculated by doing the FFT of the correlation lags and taking a square of the absolute of each term. The perceived Doppler spread at the network apparatus (202) may depend on number of correlation lags reported, called a windowing effect.

The PSD, which involves the FFT of correlation values for lag values has the problem of windowing. When a signal is windowed and FFT is taken, the effective bandwidth of the signal increases due to windowing. This increase is more prominent for small windows. So, the perceived Doppler spread of the PSD increases as the number of correlation lags that are reported is reduced. For a given sampling periodicity of the TRS, an increase in effective Doppler spread means a reduction in the maximum speed supported, as the maximum normalized Doppler spread should be less than unity.

In an embodiment, when a signal is windowed and the FFT of the windowed signal is computed, because of the windowing the signal bandwidth (in this case Doppler spread) increases. This increase is more for smaller windows, which may help in determining on how many lags need to be reported. As lesser the lags are reported, the BW (Bandwidth) or effective Doppler spread increases and the maximum supported speed (Normalized Doppler spread should be less than one or fDT (doppler shift) is between 0 and 0.5) becomes lesser for a given sampling periodicity.

Linear interpolation is method where, value is estimated based on adjacent values

$$y = {y}_{1} + ( x - {x}_{1} ) * \frac{y 2 - y 1}{x 2 - x 1} \qquad ( ii )$$

where (x₁, y₁), (x₂, y₂) are known points and (x,y) are points where for given x,y value is estimated based on slope of known points. It is one of the simplest methods for interpolation. Slope of new value remains same. Error is high in linear interpolation to compare to polynomial based interpolation. The number of correlation lags to be reported by the UE (201) may be decided by the UE (201) and be part of the TDCP report. The number of correlation lags to be reported by the UE (201) may be configured by the network apparatus (202) as well. For a given subcarrier spacing, periodicity P, carrier frequency the maximum speed supported are all related. The PSD may be calculated by doing FFT of the correlation lags and taking square of the absolute of each term. The perceived Doppler spread at the network apparatus (202) depends on the number of correlation lags reported, called as windowing effect.

In an embodiment, the present disclosure describes CSI-RS related feedback. The length N4 of Doppler basis depends on the UE's capability of prediction as well as a Doppler value. The network apparatus (202) may configure this based on the UE capability information and the network apparatus (202) has or receive Doppler information from the TRS-TDCP feedback or even from the CSI-RS feedback. Alternatively, the UE (201) may inform the network apparatus (202) in the CSI report about this.

In an embodiment of present disclosure describes the feedback of quantized autocorrelation for various lags. The N correlation lags are reported by the UE (201) to the network apparatus (202). The value N correlation lags are RRC configured by the network apparatus (202). The network apparatus (202) may also configure the correlation lags.

In one of the embodiments, feedback of quantized autocorrelation may be reported through MAC-CE or in DCI payload. The network apparatus (202) may estimate N value from an uplink channel such as Sounding Reference Signal/Physical Downlink Control Channel/Physical Downlink Scheduling (SRS/PDCCH/PDSCH).

In another embodiment, minimum values required for correlation lags are computed by the UE (201), and these values are sent directly to the network apparatus (202). Thereafter, the network apparatus (202) estimates the N from payload bits sent by the UE (201). For each number of correlation lags, payload bits are constant. Based on quantization bits used, from payload bits, N is estimated.

In one of the embodiments, the network apparatus (202) estimates the correlation values for lags values by curve fitting to the uplink channel of a single port by translating to downlink frequency for FDD (Frequency division duplex) or based on reciprocity for TDD (Time division duplex).

In another embodiment, the UE (201) estimates number of correlation lags based on curve fitting with original Doppler spectrum. Different methods may be used to estimate minimum number of correlation values for lags.

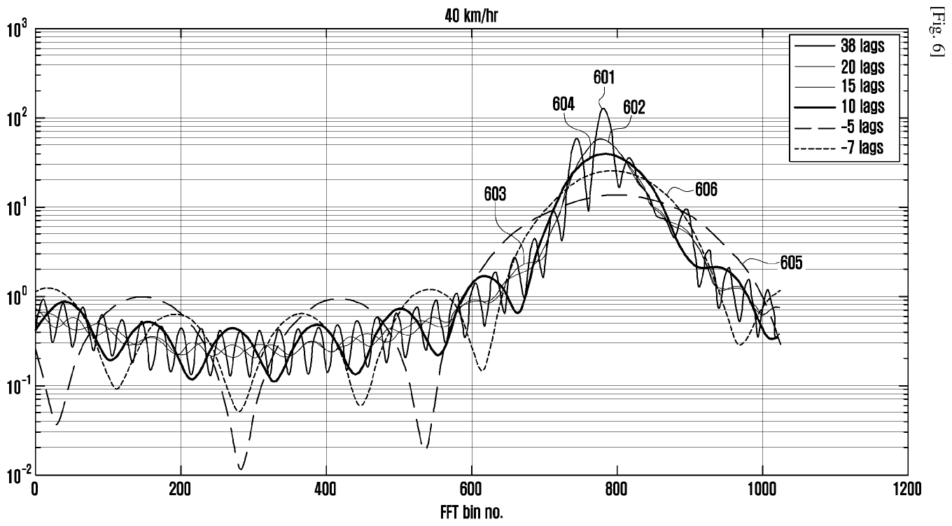

FIG. 5 is a graph illustrating the power spectral density for various speeds wherein the normalized Doppler spread is proportional to speed, in accordance with some embodiments of the present disclosure;

Referring to FIG. 5 depicts the power spectral density for various speeds includes speed of 10 kms/hr (501), speed of 20 kms/hr (502), speed of 30 kms/hr (503), speed of 40 kms/hr (504), and speed of 50 kms/hr (505). The parameters that are used are the CDL-A, 300 ns, 3.5 GHZ, 30 kHz subcarrier spacing, and periodicity 5 slots.

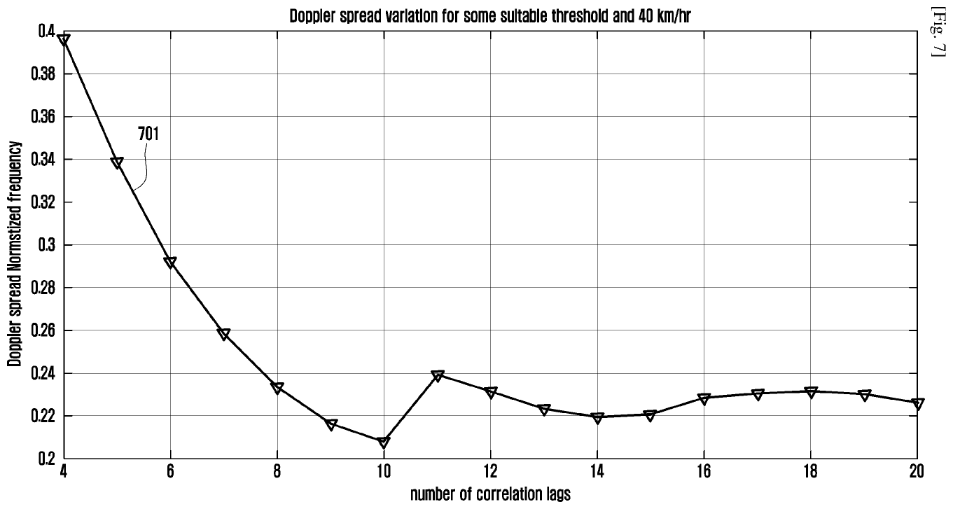

FIG. 6 is a graph illustrating the Doppler spread with number of lags, in accordance with some embodiments of the present disclosure;

Referring to FIG. 6 depicts number of lags used for PSD due to windowing effect. FIG. 6 depicts 38 lags (601), 20 lags (602), 15 lags (603), 10 lags (604), 5 lags (605), and 7 lags (606).

Generally, when a signal is windowed and computed, FFT of the windowed signal is windowed as well, because of the windowing the signal bandwidth (in this case Doppler spread) increases. This increase is more for smaller windows which help on how many lags need to be reported. As lesser the lags are reported, the BW or effective Doppler spread increases and maximum supported speed (Normalized Doppler spread should be less than one or fDT is between 0 and 0.5) may become lesser for a given sampling periodicity.

Further, according to the present invention, the PSD, which involves the FFT of correlation lag values has the problem of windowing. When a signal is windowed and FFT taken, the effective bandwidth of the signal increases due to windowing. This increase is more prominent for small windows. Therefore, the perceived Doppler spread of the PSD increases as the number of correlation lags that are reported is reduced. For a given sampling periodicity of the TRS, an increase in effective Doppler spread means a reduction in the maximum speed supported, as the maximum normalized Doppler spread should be less than unity.

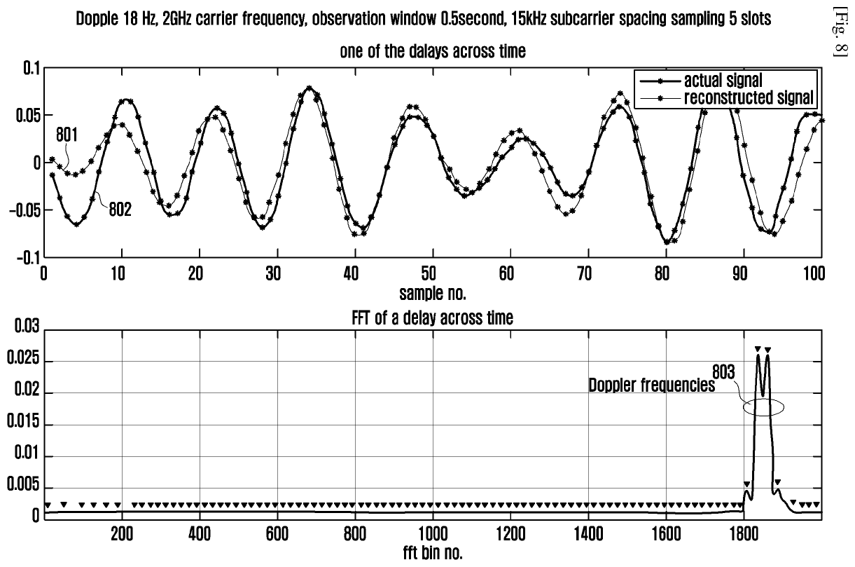

FIG. 7 is a graph illustrating the variation of doppler spread vs. number of correlation lags in PSD calculation, in accordance with some embodiments of the present disclosure; FIG. 7 includes Doppler spared 701.

At least 10 lags are required. CDL-A, 300 ns, 3.5 GHZ, 30 kHz subcarrier spacing, periodicity 5 slots. These parameters are used for the variation of doppler spread vs. number of correlation lags in PSD calculation.

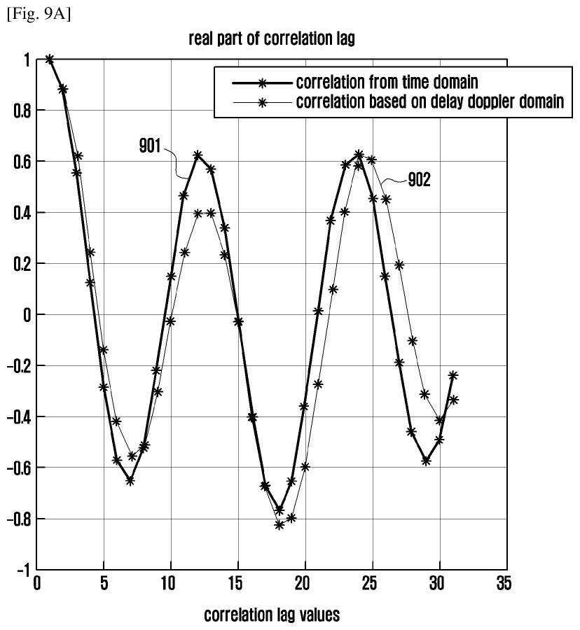

FIG. 8 is a graph illustrating a delay-doppler, in accordance with some embodiments of the present disclosure;

FIG. 8 depict an actual signal 801, and a reconstructed signal (802) and Doppler frequencies (803). In an embodiment, there are limited dominant delays or multipaths. Each multipath has a few dominant Doppler frequencies (803) only. If dominant Doppler frequencies (803) for all delays are reported, much information on the channel is available at the network apparatus (202). As illustrated in the FIG. 8, IFFT of subcarriers Res are taken and next step is to move to the delay domain. For a dataset of 624 subcarriers across 52 RBs, there are 156 TRS Res. Therefore, 1024-point IFFT and 15 delays are considered. Wherein for each delay across time, there are 1-2 Doppler frequencies (803) that needs to be reported. The network apparatus (202) then calculates correlation values based on the reported Doppler frequencies (803) in the delay domain.

For example, as illustrated in the FIG. 8, the reconstructed signal (802) depicts a reconstructed delay value across time based on just two Doppler frequencies (803) which gives out a fairly good reconstruction.

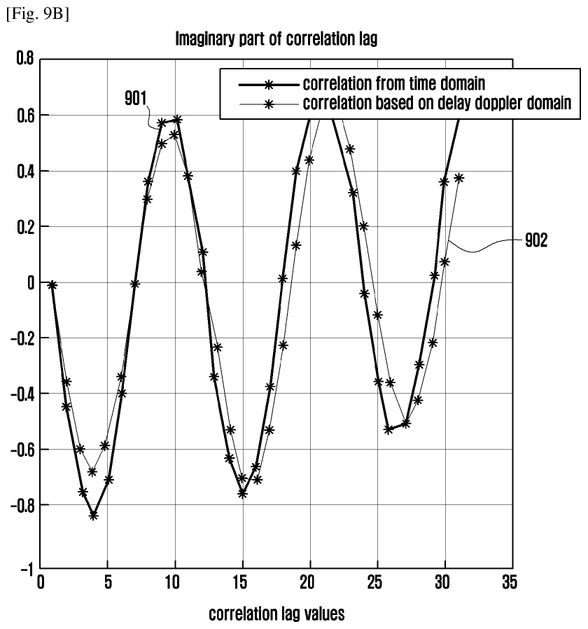

FIG. 9A is a graph illustrating a real part of correlation lag, in accordance with some embodiments of the present disclosure;

Referring to FIG. 9A depicts the correlation based on Delay-Doppler. FIG. 9A includes a correlation from time domain (901), and a correlation based on delay doppler domain (902).

FIG. 9B is a graph illustrating an imaginary part of correlation lag, in accordance with some embodiments of the present disclosure;

Referring to FIG. 9B depicts the correlation based on Delay-Doppler. FIG. 9B includes the correlation from time domain (901), and the correlation based on delay doppler domain (902).

In an embodiment, if the delay values across antennas are processed by FFT (or IFFT), beams (angles) per delay are produced. These angles may be reported via the TDCP reporting as well. Followed by reporting dominant beams across the delay and Doppler domains. This requires pilot signals across many transmit ports in order to use CSI-RS or have a new TRS similar to CSI-RS over many transmit antenna ports.

In an embodiment, the length N4 of Doppler basis depends on the UE's capability of prediction as well as Doppler value. The network apparatus (202) may configure this based on the UE capability information as the UE capability information includes Doppler information obtained from the TRS-TDCP feedback or even from the CSI-RS feedback. Alternatively, the UE (201) may inform the network apparatus (202) in the CSI report about the same.

The number of Doppler basis that needs to be reported depends upon Doppler and length N4 as follows. It may be required to report the basis for w2~ corresponding to a delay, a beam (column of w1) across N4 time instants. Let it be represented by a N4×1 vector y. Here w2~, w1, and the like represent existing techniques and may not be required to be defined here as the terms are well known.

Y=F x, where F is N4×N4 and x is N4×1 vector. Here F is FFT matrix (an example of basis). Let F (a) be the first columns of F. let x (a) be the first values of x. let Y1=F(a) x(a) be the reconstructed estimate of Y. How optimal is Y1 an approximation of Y depends on value of a. If r=(Y1-Y)′*(Y1-Y)/(Y′*Y) then r close to one means good reconstruction. Here Y′ means Hermitian (conjugate transpose) of Y.

Generally, an average value of r depends on Doppler information. Since a (the number of time-domain basis) is dependent on r, the network apparatus (202) may configure the UE (201) with the number of time domain basis once it has relevant Doppler information (via TRS TDCP feedback for instance). Also, the value of r may vary from one instance (realization) to another for a given Doppler. Hence, for one instance (realization), the network apparatus (202) may inform the UE (201) to report or use a corresponding to a specific value of r. Likewise, the UE (201) may also determine by its own criteria a value of a and report it in CSI-RS related feedback.

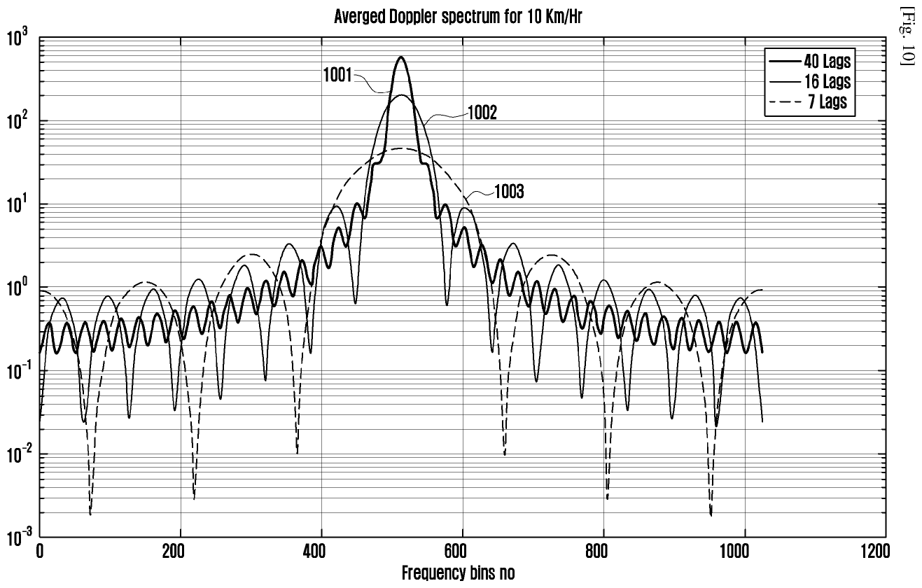

FIG. 10 is a graph illustrating the power spectral density for various lags computed from the feedback of unquantized correlation lags values, in accordance with some embodiments of the present disclosure;

Referring to FIG. 10 depicts the averaged doppler spectrum includes 40 lags (1001), 16 lags (1002), and 7 lags (1003).

In an embodiment, the feedback of quantized autocorrelation for various Lags includes, the N correlation values for lags are reported by the UE (201) to the network apparatus (202). The value N correlation lags are RRC configured by the network apparatus (202). The network apparatus (202) may configure the correlation lags. In one of the embodiment, the correlation lags may be reported through MAC-CE or in DCI payload. The network apparatus (202) may estimate N value from the uplink channel such SRS/PDCCH/PDSCH. In another embodiment, Minimum values required correlation lags are computed by the UE (201), and these values are sent directly to the network apparatus (202). The network apparatus (202) may estimate the N from payload bits sent by the UE (201). For each Number correlation lags, payload bits are constant. Based on quantization bits used, from payload bits, N is estimated.

Number of correlation lags: In one of the embodiments, the network apparatus (202) may estimate the correlation lags values by curve fitting to the uplink channel of single port by translating to downlink frequency for FDD or based on reciprocity for TDD. In another embodiment, the UE (201) may estimate the number of correlation value for lags based on curve fitting with original Doppler spectrum. Different methods may be used to estimate the minimum number of correlation lags.

The Power spectral Density (PSD) is computed from feedback of unquantized correlation lags. At the UE (201) side, estimated channel from TRS over the period 0.5 sec is used to calculate normalized autocorrelation. FIG. 10 illustrates PSD for different values of correlation lags. For 10 Km/hr, 16 correlation lags (1002) are best estimate of lags. For 7 lags (1003), it is an overestimate of Doppler spread compared to 40 lags (1001) and 16 correlation lags values (1002). Even values lower than 16 lags might give close estimate of Doppler spread with few increase in spread values. Note that the PSD, which involves the FFT of correlation lag values has an issue due to windowing. When a signal is windowed and the FFT is taken, the effective bandwidth of the signal increases due to windowing. This increase is more prominent for smaller windows.

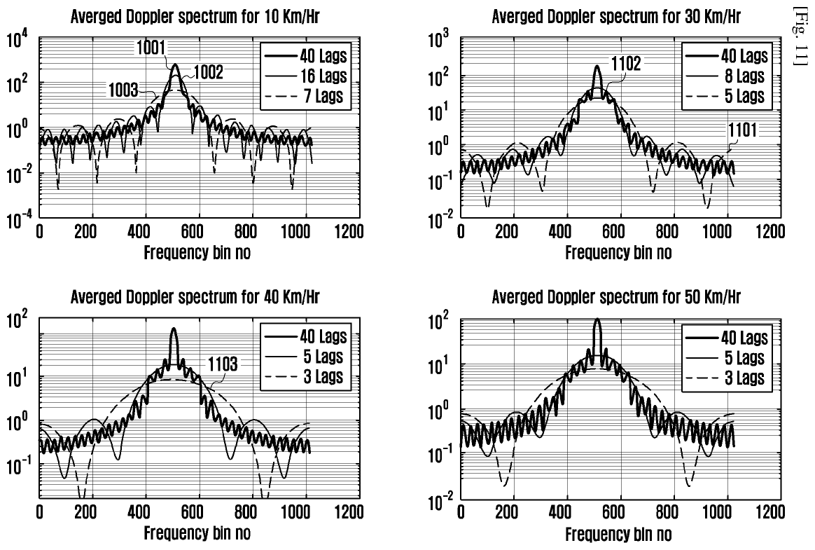

FIG. 11 is a graph illustrating the power spectral density for various correlation lags and velocities computed from feedback of unquantized correlation value for lags, in accordance with some embodiments of the present disclosure;

The averaged doppler spectrum includes 40 lags (1001), 16 lags (1002), and 7 lags (1003), 5 lags (1101), 8 lags (1102), 3 lags (1103)

The PSD is computed from feedback of unquantized correlation values. At the UE (201) side, the estimated channel from TRS over the period 0.5 sec is used to calculate normalized autocorrelation for various velocities. As velocity increase the number of correlation lags required are less is observed. For 10 km/hr., 16 lags (1002) are required to match the exact Doppler spread at the UE (201) but for 30 km/hr., only 5 lags (1101) are required to match the Doppler spread. Less values of correlation lags spread increases the Doppler spread.

Quantized and decimated feedback of correlation values for lags: In another embodiment, the network apparatus (202) RRC configures N correlation lag. The network apparatus (202) may estimate minimum Nactual correlation lags required to reported from uplink channels estimates. Further the network apparatus (202) decimates Nactual to get N such that after linear interpolated, difference is negligible.

$$N = Decimation ( {N}_{actual} , d ) \qquad ( iii )$$

where d decimation value.

For very higher true correlation lags say above 25, d may need to be 8 otherwise for small values, d may be up to 4 to be reported. Reporting of decimation may need further 2 bits. Value d is may be RRC configured alone with N or d may be sent in MAC-CE or DCI payload based on channel variation. In one of embodiment, d may be reported by the network apparatus (202) along with N.

Table 1 and Table 2 depict quantized and decimated feedback of correlation lags values according to an embodiment of present invention.

TABLE 1

| Index | Quantization level | Bits |
|---|---|---|
| 0 | 1 | 0000 |
| 1 | (1/2)\hat{ }(1/32) | 0001 |
| 2 | (1/4)\hat{ }(1/32) | 0010 |
| 3 | (1/8)\hat{ }(1/32) | 0011 |
| 4 | (1/16)\hat{ }(1/32) | 0100 |
| 5 | (1/32)\hat{ }(1/32) | 0101 |
| 6 | (1/64)\hat{ }(1/32) | 0110 |
| 7 | (1/128)\hat{ }(1/32) | 0111 |
| 8 | (1/256)\hat{ }(1/32) | 1000 |
| 9 | (1/512)\hat{ }(1/32) | 1001 |
| 10 | (1/1024)\hat{ }(1/32) | 1010 |
| 11 | (1/2048)\hat{ }(1/32) | 1011 |
| 12 | (1/4096)\hat{ }(1/32) | 1100 |
| 13 | (1/8192)\hat{ }(1/32) | 1101 |
| 14 | (1/16384)\hat{ }(1/32) | 1110 |
| 15 | Reserved | reserved |

TABLE 2

| Value No | Quantization level | Bits |
|---|---|---|
| 0 | (1/128)\hat{ }1/2 | 000 |
| 1 | (1/64)\hat{ }1/2 | 001 |
| 2 | (1/32)\hat{ }1/2 | 010 |
| 3 | (1/16)\hat{ }1/2 | 011 |
| 4 | (1/8)\hat{ }1/2 | 100 |
| 5 | (1/4)\hat{ }1/2 | 101 |
| 6 | (1/2)\hat{ }1/2 | 110 |
| 7 | 1 | 111 |

In an embodiment of present invention, the quantization procedure is described. If the TRS feedback report is configured for the single value of autocorrelation, then one value is quantized to value from the table 1 and reported accordingly. For example, if Corr=[a1; a2; a3; a4; a5; a6; a7; a8], a1 will be always =1; and it is not reported. A2 is quantized with table 1 and the feedback report contains corresponding bits to the value.

If multiple values are configured to be reported, then 1^{st} value is quantized to value from table 1 and subsequent values are reported from table 2 normalized from value a2. For example, if Corr=[a1; a2; a3; a4; a5; a6; a7; a8], a1 will be always =1; and it is not reported. Further, Corr is normalized with a2. After normalization, feedback of Corr will be [a3/a2; a4/a2; a5/a2; a6/a2; a7/a2; a8/a2]. This is quantized with table 2 and a2 is quantized table 1. A2 is reported only once per report, and the number of correlation lags to be reported depends on the UE (101) capability.

Table 3 and Table 4 depict quantized and decimated feedback of correlation lags values according to another embodiment of present invention.

TABLE 3

| Value No | Quantization level |
|---|---|
| 1 | 0.990(−20) |
| 2 | 0.984 |
| 3 | 0.974 |
| 4 | 0.960 |
| 5 | 0.936 |
| 6 | 0.90 |
| 7 | 0.841 |
| 8 | 0.748 |

TABLE 4

| Value No | Quantization level | Bits |
|---|---|---|
| 0 | (1/128)\hat{ }1/2 | 000 |
| 1 | (1/64)\hat{ }1/2 | 001 |
| 2 | (1/32)\hat{ }1/2 | 010 |
| 3 | (1/16)\hat{ }1/2 | 011 |
| 4 | (1/8)\hat{ }1/2 | 100 |
| 5 | (1/4)\hat{ }1/2 | 101 |
| 6 | (1/2)\hat{ }1/2 | 110 |
| 7 | 1 | 111 |

In an alternate embodiment of present invention, if the TRS feedback report is configured for the single value of autocorrelation, then one value is quantized to value from the table 3 and reported accordingly. For example, if Corr=[a1; a2; a3; a4; a5; a6; a7; a8], a1 will be always =1 and it is not reported. A2 is quantized with table 3 and the feedback report contains corresponding bits to the value.

If multiple values are configured to report, then 1^{st} value is quantized to value from table 1 and subsequent values are reported from table 4 normalized from value a2. For example, if Corr=[a1; a2; a3; a4; a5; a6; a7; a8], a1 will be always =1 and it is not reported. Corr is normalized with a2, after normalization, feedback of Corr will be [a3/a2; a4/a2; a5/a2; a6/a2; a7/a2; a8/a2]. This is quantized with table 4 and a2 is quantized table 3. The number of correlation lags to be reported depends on the UE (201) capability.

TABLE 5

| Index | Quantization level | Bits |
|---|---|---|
| 0 | 1 | 0000 |
| 1 | (1/2)\hat{ }(1/64) | 0001 |
| 2 | (1/4)\hat{ }(1/64) | 0010 |
| 3 | (1/8)\hat{ }(1/64) | 0011 |
| 4 | (1/16)\hat{ }(1/64) | 0100 |
| 5 | (1/32)\hat{ }(1/64) | 0101 |
| 6 | (1/64)\hat{ }(1/64) | 0110 |
| 7 | (1/128)\hat{ }(1/64) | 0111 |
| 8 | (1/256)\hat{ }(1/64) | 1000 |
| 9 | (1/32)\hat{ }(1/32) | 1001 |
| 10 | (1/64)\hat{ }(1/32) | 1010 |
| 11 | (1/128)\hat{ }(1/32) | 1011 |
| 12 | (1/16)\hat{ }(1/16) | 1100 |
| 13 | (1/32)\hat{ }(1/16) | 1101 |
| 14 | (1/64)\hat{ }(1/16) | 1110 |
| 15 | (1/128)\hat{ }(1/16) | 1111 |

TABLE 6

| Value No | Quantization level | Bits |
|---|---|---|
| 0 | (1/128)\hat{ }1/2 | 000 |
| 1 | (1/64)\hat{ }1/2 | 001 |
| 2 | (1/32)\hat{ }1/2 | 010 |
| 3 | (1/16)\hat{ }1/2 | 011 |
| 4 | (1/8)\hat{ }1/2 | 100 |
| 5 | (1/4)\hat{ }1/2 | 101 |
| 6 | (1/2)\hat{ }1/2 | 110 |
| 7 | 1 | 111 |

Table 5 and Table 6 depict uneven quantization, according to an embodiment of present invention.

In an alternative embodiment of present invention, if TRS feedback report is configured for single value of autocorrelation, then one value is normalized to value from the table 5 and reported accordingly. For example, if Corr=[a1; a2; a3; a4; a5; a6; a7; a8], a1 will be always =1, and it is not reported. Further, a2 is quantized with table 5 and feedback report contains corresponding bits to the value.

If multiple values are configured to report, then 1^{st} value is quantized to value from table 5 and subsequent values are reported from table 6 normalised from value 1. For example, if Corr=[a1; a2; a3; a4; a5; a6; a7; a8], a1 will be always =1; and it is not reported. Moreover, Corr is normalized with a2, after normalization, feedback of Corr may be [a3/a2; a4/a2; a5/a2; a6/a2; a7/a2; a8/a2] this is quantized with table 6 and a2 is quantized table 5. a2 is reported only once per report, the number of correlation lags to be reported depends on the UE capability.

In the above-described embodiments of present invention, reporting autocorrelation in TRS feedback to the network apparatus (202) and quantization methods that may be used to report the autocorrelation are described.

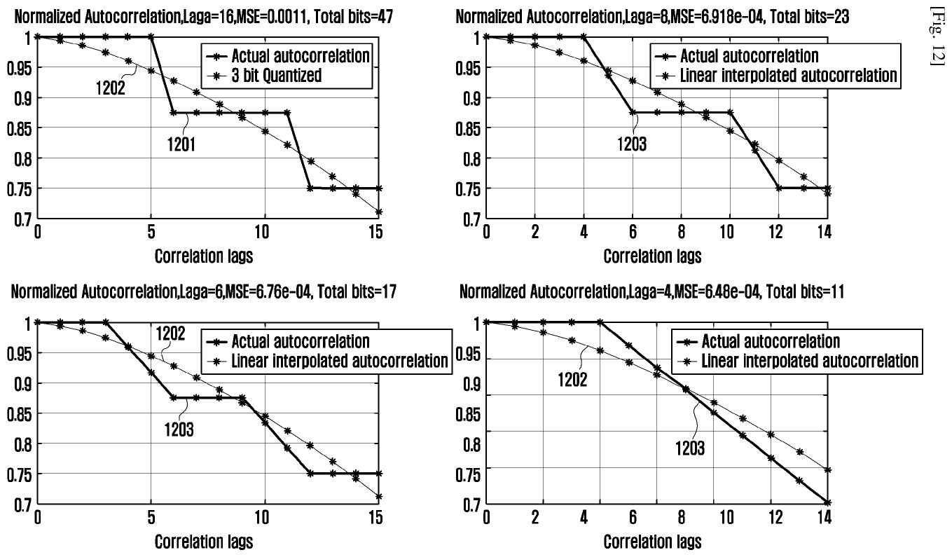

FIG. 12A, FIG. 12B, FIG. 12C and FIG. 12D are graphs illustrating normalized unquantized autocorrelation vs quantized or/and linear interpolated for various correlation lags, in accordance with some embodiments of the present disclosure.

Referring to FIG. 12A, FIG. 12B, FIG. 12C and FIG. 12D includes a 3 bit quantization (1201), an actual autocorrelation (1202), and a linear interpolated autocorrelation (1203).

The PSD is computed from the feedback of unquantized correlation lags values. With 3-bit quantization and levels at 0.125 interval, for 10 Km/hr and 16 lags, FIG. 12A, FIG. 12B, FIG. 12C and FIG. 12D shows the comparison of the normalized unquantized autocorrelation and quantized or/and linear interpolated for various correlation lags at the UE (201) and the network apparatus (202). Ideal estimation of values is assumed at the network apparatus (202). In the FIG. 12A top left plot, shows the autocorrelation at the network apparatus (202) and the UE (201). For simple 3-bit quantization with interval of 0.125, since quantization error is high as evident from figure, MSE with actual autocorrelation and quantized is high. Also payload bits need to send is quite high for 16 lags.

$$MSE = {\sum }_{lags} {\vert A ( t , τ ) - \text{?} ( t , τ ) \vert}^{2} \qquad ( iii )$$

$$Total Payload bits = ( Lags - 1 ) * 3 + 2$$

For total payload bits, 3-bit quantizer for lags excluding correlation lag 0 since it is always 1. The 2 bits is to report decimation in lags. Simple linear interpolation is assumed to extrapolate the correlation values at the network apparatus (202). In the FIG. 12B, top right plot, depicts the UE (201) reports 8 quantized correlation values and with linear interpolation the network apparatus (202) estimates correlation values. As shown in FIG. 12A, MSE is reduced significantly and payload is close to halved. This is quite intuitive also, as interpolated values may be closer than true values compared to quantized values. Similarly, from remaining plots in FIG. 12C and FIG. 12D depicts MSE and Payload for different lags values.

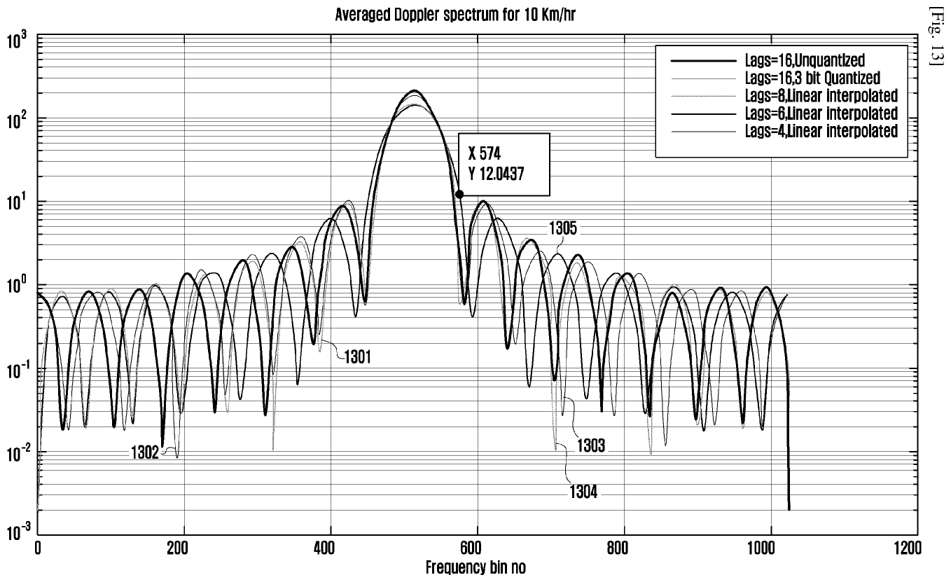

FIG. 13 is a graph illustrating the power spectral density for various correlation values at the network apparatus with linear interpolation and unquantized at the UE, in accordance with some embodiments of the present disclosure.

Referring to FIG. 13 includes 16 lags unquantized (1301), 16 lags 3 bit quantized (1302), 8 lags linear interpolated (1303), 6 lags linear interpolated (1304), and 4 lags linear interpolated (1305).

Based on quantization and linear interpolation, Doppler spread for various lags at the network apparatus (202) is computed and compared with Doppler spread at the UE (201). FIG. 13 illustrates the Doppler spread is nearly same for quantized and till 6 lags (1304). For 4 lags (1305), Doppler spread is greater than original unquantized Doppler spread. As payload bits for 4 lags (1305) is less compared to other higher lags and nearly same MSE as seen above plots, trade off comes at little greater Doppler spread at the network apparatus (202).

Without feedback range of quantization, quantization error may be huge at the network apparatus (202). The UE (201) may send the values with very high error. Instead of setting fixed range for all the values, dynamic range can be set with trade-off of extra 2 or 3 bits to set lower range. The higher range may always be 1. The feedback of autocorrelation values with lower range quantization gives much better estimate than fixed range. Setting of fixed or dynamic range, may be configured by the network apparatus (202) based on type of scenario. The configuration may be done with single bit in RRC or MAC-CE or DCI in different embodiments. For fixed levels, Bit 0 and Bit 1 for dynamic levels or vice versa. These extra bits are reported by the UE (201) alone with quantized correlation values in the TDCP report.

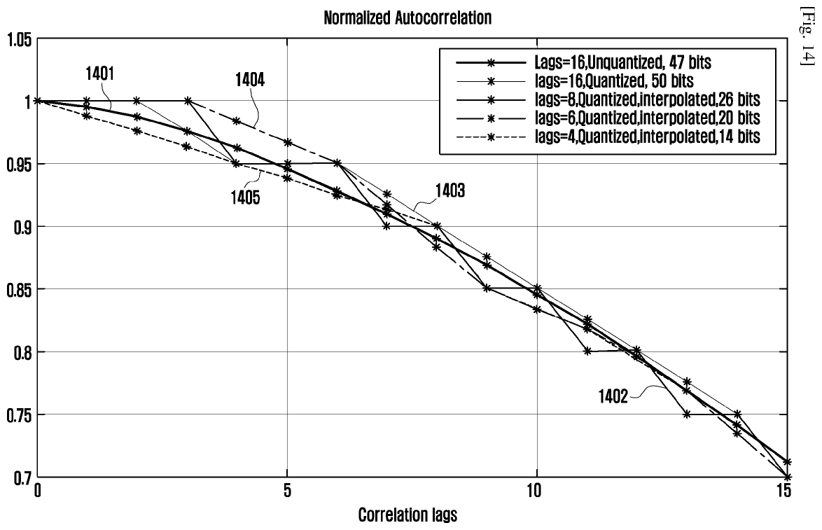

FIG. 14 is a graph illustrating an autocorrelation for 15 lags using 3-bit quantization with varying quantization level, in accordance with some embodiments of the present disclosure.

Referring to FIG. 14 includes 16 lags unquantized 47 bits (1401), 16 quantized 50 bits (1402), 8 lags linear interpolated (1403), 6 lags linear interpolated (1404), and 4 lags linear interpolated (1405).

Autocorrelation is compared with 3-bit quantization and varying quantization level for different correlation lag values with linear interpolation and autocorrelation at the UE (201). As evident from FIG. 14, with this type of quantization correlation lag values matches at cost of extra 3 bits to send starting value. In the FIG. 14, level at 0.05 is used starting at 0.6.

Table 7 is parameter and the patameters' value

TABLE 7

| Parameter | Value | |
|---|---|---|
| Delay spread | 300 | nsec |
| Number of subcarriers | 156 | |
| Periodicity | 2.5 | msec |
| Autocorrelation Lags | 50 | |
| FFT | 1024 | |
| Frequency | 3.5 | GHz |
| Velocity | 10 | Km/Hr |
| Subcarrier Spacing | 30 | KHz |
| Max Doppler shift | 32.4 | Hz |

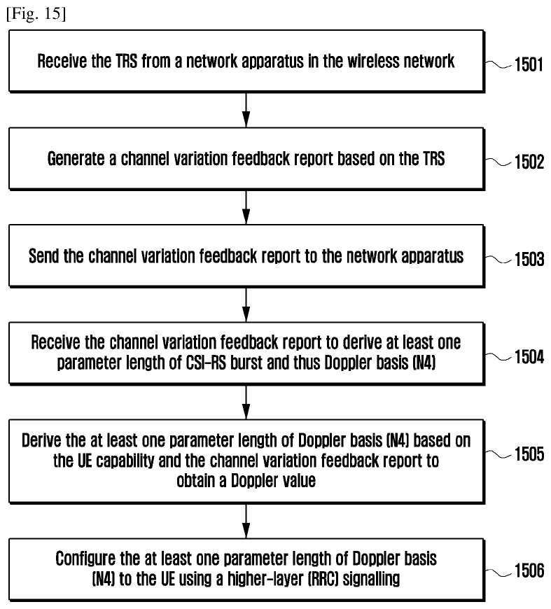

FIG. 15 is a flow chart illustrating a method for handling channel variation feedback report based on Tracking Reference Signals (TRS) in a wireless network, according to the embodiment as disclosed herein.

At step 1501, receiving, by the user equipment (UE) in the wireless network, the TRS from the network apparatus in the wireless network;

At step 1502, generating, by the UE, the channel variation feedback report based on the TRS;

At step 1503, sending, by the UE, the channel variation feedback report to the network apparatus;

At step 1504, receiving, by the network apparatus, the channel variation feedback report to derive parameter length of Doppler basis (N4);

At step 1505, deriving, by the network apparatus, the parameter length of Doppler basis (N4) based on the UE capability and the channel variation feedback report to obtain a Doppler value; and

At step 1506, configuring, by the network apparatus, the parameter length of Doppler basis (N4) to the UE using a higher-layer (RRC) signaling.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1. A method of a user equipment (UE) (201), for handling channel variation feedback report based on tracking reference signals (TRS) in a wireless network, comprising:
receiving the TRS from a network apparatus (202) in the wireless network;
generating the channel variation feedback report based on the TRS; and
sending the channel variation feedback report to the network apparatus (202).

2. The method of claim 1, wherein generating the channel variation feedback report based on the TRS comprises:
determining frequency and time offsets in the between the network apparatus (202) and the UE (201);
determining a downlink channel;
performing quantized autocorrelation from the downlink channel to obtain for candidate values for correlation lags; and
generating the channel variation feedback report based on the candidate values for the number of correlation lags.

3. The method of claim 1,
wherein the channel variation feedback report comprises time domain correlation property (TDCP),
wherein the TDCP comprises at least one of feedback of the quantized amplitude autocorrelation for correlation lags, and
wherein the candidate values for number of correlation lags are configured through higher layer RRC signaling.

4. The method of claim 1, wherein sending the channel variation feedback report to the network apparatus (202), comprises:
varying the candidate values for the number of correlation lags and candidate values for correlation lags to be reported to the network apparatus based on a linear interpolation model and a quantization model;
reporting the candidate values for the number of correlation lags depends on the UE to the network apparatus; and
wherein the power spectral density (PSD) and doppler spectrum are fast fourier transform (FFT) of the candidate values for correlation lags are monitored by an absolute and squared operation.

5. A method of a network apparatus (202) for handling channel variation feedback report based on tracking reference signals (TRS) in a wireless network, comprising:
configuring value for number correlation lags through higher layer RRC signaling at a UE (201);
sending the TRS to the UE (201) in the wireless network (206); and
receiving the channel variation feedback report from the UE (201) based on the TRS.

6. The method of claim 5, further comprising:
adjusting a beam forming operation between the UE (201) and the network apparatus (202) based on the channel variation feedback report.

7. The method of claim 5, wherein configuring value for correlation lags through higher layer RRC signaling at the UE (201) comprises:
detecting at least one of a capability information of the UE (201);
configuring values for number correlation lags through the higher layer RRC signaling at the UE (201) based on at least one of the capability information of the UE (201).

8. The method of claim 5, further comprising:
receiving doppler information from at least one of a tracking reference signals-time domain correlation property (TRS-TDCP) feedback and a channel state information-reference signal (CSI-RS) feedback from the UE (201);
The method as claimed in claim 11, wherein the capability information of the UE (201) comprises the candidate values of number of lags supported by the UE (201).

9. A user equipment (UE) (201) for handling channel variation feedback report based on tracking reference signals (TRS) in a wireless network (206), the UE comprising:
a transceiver; and
a processor configured to:
receive the TRS from a network apparatus (202) in the wireless network,
generate the channel variation feedback report based on the TRS, and send the channel variation feedback report to the network apparatus (202).

10. The UE of claim 9, wherein the processor is further configured to:
determine frequency and time offsets in the between network and UE, determine a downlink channel,
perform quantized autocorrelation from the downlink channel to obtain for candidate values for correlation lags, and
generate the channel variation feedback report based on the candidate values for the number of correlation lags.

11. The UE of claim 9,
wherein the channel variation feedback report comprises time domain correlation property (TDCP),
wherein the TDCP comprises at least one of feedback of the quantized amplitude autocorrelation for correlation lags, and
wherein the candidate values for number of correlation lags are configured through higher layer RRC signaling.

12. The UE of claim 9, wherein the processor is further configured to:
vary the candidate values for the number of correlation lags and candidate values for correlation lags to be reported to the network apparatus based on a linear interpolation model and a quantization model,
report the candidate values for the number of correlation lags depends on the UE to the network apparatus, and
determine a power spectral density (PSD) and doppler spectrum are fast fourier transform (FFT) based on the candidate values for the number correlation lags and candidate values for correlation lags, and wherein the PSD and doppler spectrum are FFT of the candidate values for correlation lags are monitored by an absolute and squared operation.

13. A network apparatus (202) for handling channel variation feedback report based on tracking reference signals (TRS) in a wireless network (206), the network apparatus comprising:
a transceiver; and
a processor configured to:
configure value for number correlation lags through higher layer RRC signaling at a UE (201),
send the TRS to the UE (201) in the wireless network (206), and receive the channel variation feedback report from the UE (201) based on the TRS.

14. The network apparatus (202) of claim 13, wherein the processor is further configured to:
adjust a beam forming operation between the UE (201) and the network apparatus (202) based on the channel variation feedback report.

15. The network apparatus of claim 13, wherein the processor is further configured to:
detect at least one of a capability information of the UE (201), configure values for number correlation lags through the higher layer RRC signaling at the UE (201) based on at least one of the capability information of the UE (201).
